(19) United States
(12) Patent Application Publication
(10) Pub. No.: US 2020/0007340 A1
(43) Pub. Date: Jan. 2, 2020

(54) INTERNET OF THINGS SECURITY MODULE

(71) Applicant: CIOT CO., LTD., Busan (KR)

(72) Inventors: Hyeon Ju PARK, Yongin-si (KR); Han Na PARK, Incheon (KR)

(21) Appl. No.: 16/482,019

(22) PCT Filed: Mar. 28, 2017
(86) PCT No.: PCT/KR2017/003359

§ 371 Date: Jul. 30, 2019

(30) Foreign Application Priority Data
Feb. 2, 2017 (KR) 10-2017-0014986

(51) Int. Cl. H04L 9/32; H04L 9/08; G06F 21/60

(52) U.S. Cl. CPC H04L 9/3234; G06F 21/602; H04L 9/0869

(57) ABSTRACT

An Internet of Things (IoT) security module that easily interfaces with an electronic device and performs security functions includes: at least one of an authentication function; an encryption and decryption function; a random number generation function; and a storage function. An IoT security hardware develops an interface to be easily attached to and detached from a general-purpose open board for building an IoT environment and makes security features easy to use on the general-purpose open board. The IoT security module includes an interface unit which interfaces with the electronic device and receives one of the security functions from the electronic device, where the security functions include authentication function, encryption and decryption function, random number generation function, and storage function; and an authentication unit which determines whether the ID and unique number of the electronic device input through the interface unit match the prestored ID and unique number.

### BACKGROUND

### 1. Field of the Invention

The present invention relates to an Internet of Things security module that is easily interfaced with an electronic device to perform security functions including at least one among an authentication function, an encryption and decryption function, a random number generation function, and a storage function.

### 2. Description of Related Art

With all the tremendous advancement in security, hacking frequently occurs in the field of information communication technology. Therefore, a framework for security of Internet of Things (IoT) which distinguishes several devices needs to be proposed.

As interest in the Internet of Things increases, many products related to the Internet of Things are released, and as open boards that can be universally used are released, various layers and groups release IoT devices and services.

However, as the Internet of Things is based on open Internet networks and wireless communications, an IoT device connected to a network may be a target of malicious attackers, and this may affect the overall system. Particularly, since health care services, to which the Internet of Things is rapidly applied, are related to the life of users, it may generate a critical problem.

Accordingly, interest in IoT security increases in reality. However, professional knowledge is required to apply IoT security techniques to an IoT device, and it is very difficult to apply the techniques in reality since the cost for adopting the techniques, such as customizing the techniques to a corresponding device or the like, is also very high.

Accordingly, it is required to develop a hardware-type IoT security module so that various layers may easily apply the techniques targeting general-purpose open boards and to solve the problems through an education method using the module.

### SUMMARY OF THE INVENTION

Therefore, the present invention has been made in view of the above problems, and it is an object of the present invention to develop an interface in a form that can be easily attached to and detached from a general-purpose open board used for construction of an Internet of Things environment and propose an Internet of Things security hardware for easy use of security functions on the general-purpose open board.

Another object of the present invention is to perform security functions including at least one among an authentication function, an encryption and decryption function, a random number generation function, and a storage function by connecting the proposed hardware to a general-purpose open board.

The problems to be solved by the present invention are not limited to the problems described above, and diverse problems may be included within the scope apparent to those skilled in the art from the descriptions described below.

To accomplish the above objects, according to one aspect of the present invention, there is provided an Internet of Things security module including: an interface unit interfaced with an electronic device to receive any one of security functions, including an authentication function, an encryption and decryption function, a random number generation function and a storage function, inputted by the electronic device; and an authentication unit for determining whether an ID and a unique number of the electronic device inputted through the interface unit match an ID and a unique number stored in advance.

In addition, according to another aspect of the present invention, the authentication unit outputs a match signal to the electronic device if the inputted ID and unique number match an ID and a unique number stored in advance.

In addition, according to still another aspect of the present invention, the Internet of Things security module further includes an encryption and decryption unit for encrypting information to be encrypted on the basis of the information to be encrypted, an encryption method and a key value inputted through the Interface unit and outputting the encrypted information to the electronic device.

In addition, according to still another aspect of the present invention, the Internet of Things security module further includes a random number generation unit for generating a random number on the basis of a random number size inputted through the Interface unit.

In addition, according to still another aspect of the present invention, the Internet of Things security module further includes a storage unit for storing the unique number and the key value of the electronic device inputted through the Interface unit.

### Advantageous Effects

The present invention may develop an interface in a form that can be easily attached to and detached from a general-purpose open board used for construction of an Internet of Things environment and propose an Internet of Things security hardware for easy use of security functions on the general-purpose open board.

The proposed invention may perform security functions including at least one among an authentication function, an encryption and decryption function, a random number generation function, and a storage function by connecting the proposed hardware to a general-purpose open board.

The effects of the present invention are not limited to the effects described above, and diverse effects may be included within the scope apparent to those skilled in the art from the descriptions described below.

### BRIEF DESCRIPTION OF THE DRAWINGS

FIG. 1 is a view showing the configuration of an Internet of Things security module according to an embodiment.

FIG. 2 is a flowchart illustrating the flow of an Internet of Things security module according to an embodiment.

### DETAILED DESCRIPTION OF THE INVENTION

The above and additional aspects are specified through the embodiments described with reference to the accompanying drawings. It is understood that the constitutional components of the embodiments can be diversely combined within the embodiments unless mentioned otherwise or mutually contradictory. Furthermore, the proposed invention may be implemented in various different forms and is not limited to the embodiments described herein.

The elements unrelated to the description are omitted from the drawings to clearly describe the proposed invention, and similar reference symbols are assigned to similar elements throughout the specification. In addition, when an element is referred to as “including” another constitutional component, this means further including another constitutional component, not excluding another constitutional component, as far as an opposed description is not specially specified.

In addition, throughout the specification, when an element is referred to as being “connected” to another element, it also includes a case of “electrically connecting” the element with intervention of another element therebetween, as well as a case of “directly connecting” the element. Furthermore, throughout the specification, a signal means an electric quantity such as voltage, current or the like.

A unit described in this specification means a “block which configures a system of hardware or software to be changed or plugged in”, which means a unit or a block performing a specific function in hardware or software.

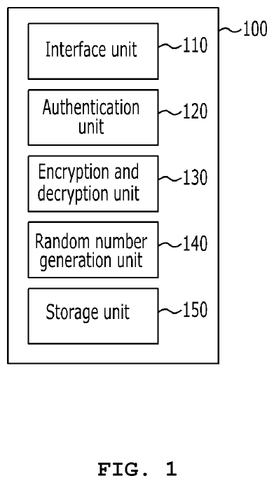

FIG. 1 is a view showing the configuration of an Internet of Things security module according to an embodiment.

In an embodiment, an Internet of Things security module 100 includes an interface unit 110 interfaced with an electronic device to receive any one of security functions, including an authentication function, an encryption and decryption function, a random number generation function and a storage function, inputted by the electronic device; and an authentication unit 120 for determining whether an ID and a unique number of the electronic device inputted through the interface unit 110 match an ID and a unique number stored in advance.

In an embodiment, the Internet of Things security module 100 is a device including a GPIO interface for easy application of Internet of Things security techniques to a general-purpose open board, such as Raspberry Pi, Arduino or the like.

The electronic device is a general-purpose open board, such as Raspberry Pi, Arduino or the like. That is, the electronic device is a motherboard which can configure a general computer, which is a general-purpose motherboard which can configure a computer by attaching peripheral devices such as a CPU, memory, a video board and the like.

The motherboard includes a plurality of slots, and the slots may be GPIO interfaces for input and output.

In an embodiment, the interface unit 110 is interfaced with an electronic device and receives any one of security functions inputted by the electronic device, and the security functions include an authentication function, an encryption and decryption function, a random number generation function, and a storage function.

The Internet of Things security module 100 is interfaced with an electronic device through the interface unit 110 and receives any one of security functions inputted by the electronic device. At this point, an Internet of Things security module 100 program is installed in the electronic device, and any one of the security functions may be inputted through the Internet of Things security module 100 program. The Internet of Things security module 100 program is, for example, a security program for education.

The authentication function is a function of confirming whether the electronic device interfaced with the Internet of Things security module 100 is an electronic device expected to be interfaced with.

The encryption and decryption function is a function of encrypting a specific data.

The random number generation function is a function of generating a random number of a size desired by a user.

The storage function is a function of storing some data.

A user may input any one of the security functions through an input device such as a keyboard or the like connected to the electronic device. Any one of the inputted security functions is inputted into the Internet of Things security module 100 through the interface unit 110.

In an embodiment, the authentication unit 120 determines whether an ID and a unique number of the electronic device inputted through the interface unit 110 match an ID and a unique number stored in advance.

After the authentication function is selected as a security functions, the user may input an ID and a unique number of the electronic device. The authentication unit 120 determines whether the ID and the unique number of the electronic device inputted through the interface unit 110 match an ID and a unique number stored in advance.

The ID and the unique number stored in advance are an ID and a unique number stored in a storage unit 150 described below.

In an embodiment, if the inputted ID and unique number match an ID and a unique number stored in advance, the authentication unit 120 outputs a match signal to the electronic device.

In addition, if any one of the inputted ID and unique number does not match an ID or a unique number stored in advance, the authentication unit 120 outputs a mismatch signal to the electronic device.

The authentication unit 120 authenticates the interfaced electronic device by outputting a match signal. If the authentication unit 120 outputs a match signal, a display unit such as a monitor or the like connected to the electronic device outputs a character string such as ‘Match’ corresponding to the match signal. The character string is not limited to ‘Match’ and may be diversely set, such as ‘Succeed’ or the like.

If the authentication unit 120 outputs a mismatch signal, the display unit such as a monitor or the like connected to the electronic device outputs a character string such as ‘Mismatch’ corresponding to the mismatch signal. The character string is not limited to ‘Mismatch’ and may be diversely set, such as ‘Fail’ or the like.

In an embodiment, the Internet of Things security module 100 further includes an encryption and decryption unit 130 for encrypting information to be encrypted on the basis of the information to be encrypted, an encryption method and a key value inputted through the Interface unit 110 and outputting the encrypted information to the electronic device.

In an embodiment, the encryption and decryption unit 130 encrypts information to be encrypted on the basis of the information to be encrypted, an encryption method and a key value inputted through the Interface unit 110 and outputs the encrypted information to the electronic device.

The information to be encrypted is arbitrary information inputted by a user, which is a target of encryption.

The encryption method is an encryption algorithm for encrypting the information to be encrypted. The encryption algorithm is, for example, AES, RAS, ATK or the like.

The key value is an encryption key value or a decryption key value for the encryption algorithm. The key value is a private key value or a public key value.

The encryption and decryption unit 130 encrypts the inputted information to be encrypted through the inputted encryption algorithm, which is an encryption method, and the encryption key. The encryption and decryption unit 130 outputs encrypted information to the electronic device. The electronic device outputs the encrypted information through an output device such as a monitor or the like.

In an embodiment, the Internet of Things security module 100 further includes a random number generation unit 140 for generating a random number on the basis of a random number size inputted through the Interface unit 110.

In an embodiment, the random number generation unit 140 generates a random number on the basis of a random number size inputted through the Interface unit 110.

The random number generation unit 140 may be implemented as a hardware chipset separated from the other configurations that the Internet of Things security module 100 includes.

The random number size is a data size of a random number, and it is a length of the random number. The random number size may be, for example, equal to or larger than 8 bytes and equal to or smaller than 16 bytes.

The random number generation unit 140 generates a random number corresponding to the inputted random number size.

In an embodiment, the Internet of Things security module 100 further includes a storage unit 150 for storing the unique number and the key value of the electronic device inputted through the Interface unit 110.

The storage unit 150 may be implemented as a hardware chipset separated from the other configurations that the Internet of Things security module 100 includes. The authentication unit 120 described above may be implemented as software executed by a microcontroller unit which generally controls the Internet of Things security module 100. The storage unit 150, the random number generation unit 140 and the microcontroller unit described above are installed in a board as chipsets independent from each other.

The unique number of the electronic device is a number individually assigned to each electronic device. The key value has been described above.

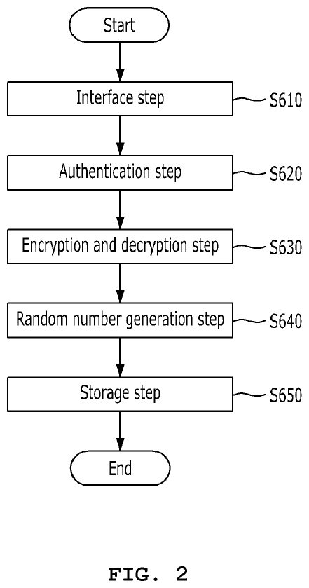

FIG. 2 is a flowchart illustrating the flow of an Internet of Things security module according to an embodiment.

In an embodiment, an Internet of Things security method includes: an interface step (step S610) of interfacing an interface unit with an electronic device and receiving any one of security functions, including an authentication function, an encryption and decryption function, a random number generation function, and a storage function, inputted by the electronic device; and an authentication step (step S610) of determining whether an ID and a unique number of the electronic device inputted through the interface step match an ID and a unique number stored in advance (step S620).

In an embodiment, the Internet of Things security method is a method of a device including a GPIO interface for easy application of Internet of Things security techniques to a general-purpose open board, such as Raspberry Pi, Arduino or the like.

The electronic device is a general-purpose open board, such as Raspberry Pi, Arduino or the like. That is, the electronic device is a motherboard which can configure a general computer, which is a general-purpose motherboard which can configure a computer by attaching peripheral devices such as a CPU, memory, a video board and the like.

The motherboard includes a plurality of slots, and the slots may be GPIO interfaces for input and output.

In an embodiment, at the interface step (step S610), the interface unit 110 is interfaced with an electronic device and receives any one of security functions inputted by the electronic device, and the security functions include an authentication function, an encryption and decryption function, a random number generation function, and a storage function.

In the Internet of Things security method, the interface unit 110 is interfaced with an electronic device through the interface step (step S610) and receives any one of security functions inputted by the electronic device. At this point, an Internet of Things security method program is installed in the electronic device, and any one of the security functions may be inputted through the Internet of Things security method program. The Internet of Things security method program is, for example, a security program for education.

The authentication function is a function of confirming whether the electronic device interfaced with the Internet of Things security module of the Internet of Things security method is an electronic device expected to be interfaced with.

The encryption and decryption function is a function of encrypting a specific data.

The random number generation function is a function of generating a random number of a size desired by a user.

The storage function is a function of storing some data.

A user may input any one of the security functions through an input device such as a keyboard or the like connected to the electronic device. Any one of the inputted security functions is inputted into the Internet of Things security method through the interface step (step S610).

In an embodiment, at the authentication step (step S620), the authentication unit 120 determines whether an ID and a unique number of the electronic device inputted through the interface step (step S610) match an ID and a unique number stored in advance.

After the authentication function is selected as a security functions, the user may input an ID and a unique number of the electronic device. At the authentication step (step S620), the authentication unit 120 determines whether an ID and a unique number of the electronic device inputted through the interface step (step S610) match an ID and a unique number stored in advance.

The ID and the unique number stored in advance are an ID and a unique number stored through a storage step (step S650) described below.

In an embodiment, if the inputted ID and unique number match an ID and a unique number stored in advance, the authentication unit 120 outputs a match signal to the electronic device at the authentication step (step S620).

In addition, if any one of the inputted ID and unique number does not match an ID or a unique number stored in advance, the authentication unit 120 outputs a mismatch signal to the electronic device at the authentication step (step S620).

At the authentication step (step S620), the authentication unit 120 authenticates the interfaced electronic device by outputting a match signal. If the authentication unit 120 outputs a match signal at the authentication step (step S620), a display unit such as a monitor or the like connected to the electronic device outputs a character string such as ‘Match’ corresponding to the match signal. The character string is not limited to ‘Match’ and may be diversely set, such as ‘Succeed’ or the like.

If the authentication unit 120 outputs a mismatch signal at the authentication step (step S620), the display unit such as a monitor or the like connected to the electronic device outputs a character string such as ‘Mismatch’ corresponding to the mismatch signal. The character string is not limited to ‘Mismatch’ and may be diversely set, such as ‘Fail’ or the like.

In an embodiment, the Internet of Things security method further includes an encryption and decryption step (step S630) of encrypting information to be encrypted on the basis of the information to be encrypted, an encryption method and a key value inputted through the interface step (step S610) and outputting the encrypted information to the electronic device.

In an embodiment, at the encryption and decryption step (step S630), the encryption and decryption unit 130 encrypts information to be encrypted on the basis of the information to be encrypted, an encryption method and a key value inputted through the interface step (step S610) and outputs the encrypted information to the electronic device.

The information to be encrypted is arbitrary information inputted by a user, which is a target of encryption.

The encryption method is an encryption algorithm for encrypting the information to be encrypted. The encryption algorithm is, for example, AES, RAS, ATK or the like.

The key value is an encryption key value or a decryption key value for the encryption algorithm. The key value is a private key value or a public key value.

At the encryption and decryption step (step S630), the encryption and decryption unit 130 encrypts the inputted information to be encrypted through the inputted encryption algorithm, which is an encryption method, and the encryption key. The encryption and decryption unit 130 outputs encrypted information to the electronic device. The electronic device outputs the encrypted information through an output device such as a monitor or the like.

In an embodiment, the Internet of Things security method further includes a random number generation step (step S640) of generating a random number on the basis of a random number size inputted through the interface step (step S610).

In an embodiment, at the random number generation step (step S640), the random number generation unit 140 generates a random number on the basis of a random number size inputted through the interface step (step S610).

The random number generation step (step S640) may be implemented as a hardware chip separated from the other configurations that the Internet of Things security method includes.

The random number size is a data size of a random number, and it is a length of the random number. The random number size may be, for example, equal to or larger than 8 bytes and equal to or smaller than 16 bytes.

At the random number generation step (step S640), the random number generation unit 140 generates a random number corresponding to the inputted random number size.

In an embodiment, the Internet of Things security method further includes the storage step (step S650) of storing the unique number and the key value of the electronic device inputted through the interface step (step S610).

The storage step (step S650) may be implemented as a hardware chipset separated from the other configurations that the Internet of Things security method includes. The authentication step (step S620) described above may be implemented as software executed by a microcontroller unit which generally controls the Internet of Things security method. The storage step (step S650), the random number generation step (step S640) and the microcontroller unit described above are installed in a board as chipsets independent from each other.

The unique number of the electronic device is a number individually assigned to each electronic device. The key value has been described above.

As described above, those skilled in the art may recognize that the present invention can be embodied in other specific embodiments without changing the spirits or essential features thereof. Accordingly, it should be understood that the embodiments described above are only illustrative and not restrictive limiting the scope. In addition, the flowcharts shown in the drawings are only sequential orders shown for illustrative purposes to attain the most desirable result in embodying the present invention, and it is apparent that other additional steps can be provided or some of the steps can be deleted.

The technical features described in this specification and the implementations executing the same may be implemented as a digital electronic circuit, implemented as computer software, firmware or hardware including the structures described in this specification or the structural equivalents thereof, or implemented as a combination of one or more of these. In addition, the implementations executing the features described in this specification may be implemented as a computer program product, in other words, a module related to computer program commands encoded on a tangible program storage medium to control the operation of the system or for the execution by the system.

A computer-readable medium may be a machine-readable storage device, a machine-readable storage substrate, a memory device, a composition of materials having an effect on machine-readable propagation-type signals, or a combination of one or more of these.

Meanwhile, in this specification, an “apparatus” or a “system” includes, for example, a processor, a computer and all devices, apparatuses and machines for processing information, including a multiprocessor or the computer. A processing system may include, in addition to hardware, all codes which form an execution environment for a computer program when it is requested, for example, a code configuring processor firmware, a protocol stack, an information base management system, an operating system, and a combination of one or more of these.

A computer program known as a program, software, a software application, a script, a code or the like may be created in any form of a programming language including a compiled or interpreted language or a declarative or procedural language and may be implemented in any form including an independent program or module, a component, a subroutine, or other units suitable for being used in a computer environment.

Meanwhile, the computer program does not necessarily correspond to a file in a file system and may be stored in a single file provided in a requested program, in multiple interacting files (e.g., files storing one or more modules, subprograms or part of a code), or in a part of a file possessing other programs or information (e.g., one or more scripts stored in a markup language document).

The computer program may be implemented to be executed in multiple computers or one or more computers located in one site or distributed across a plurality of sites and interconnected through wired/wireless communication networks.

Meanwhile, a computer-readable medium suitable for storing computer program commands and information may include, for example, all forms of nonvolatile memory, media and memory devices, including semiconductor memory devices such as EPROM, EEPROM and a flash memory device, magnetic disks such as internal hard disks or external disks, magneto-optical disks, and CD or DVD disks. The processor and memory may be supplemented by or incorporated in a special-purpose logic circuit.

The implementations executing the technical features described in this specification may be implemented in a computing system including backend components such as an information server, middleware components such as an application server, frontend components such as a client component having a web browser or a web graphical user interface, with which a user may interact with the implementations of a subject described in this specification, or all combinations of one or more of the backend, middleware and frontend components. The components of the system may interact with each other by any form or medium of digital information communication such as a communication network.

Hereinafter, further specific embodiments which can implement the configurations included in the system and method described in this specification will be described in detail, together with the contents described above.

In this specification, the method may be used in part or as a whole on a client device, a server related to a web-based storage system, or one or more processors included in the server through a means which executes computer software, program codes or commands. Here, the processor may be any one of computing platforms such as a server, a client, a network infrastructure, a mobile computing platform, a fixed computing platform and the like, and specifically, it may be a kind of computer or processing device which can process program commands, codes and the like. In addition, the processor may further include a memory for storing methods, commands, codes and programs, and when the processor does not include a memory, it may access a storage device such as a CD-ROM, a DVD, a memory, a hard disk, a flash drive, RAM, ROM, a cache or the like, in which methods, commands, codes and programs according to the present invention are stored, through a separate interface.

In addition, the system and method described in this specification may be used in part or as a whole through a device executing computer software on a server, a client, a gateway, a hub, a router or network hardware. Here, the software may be executed in various kinds of servers such as a file server, a print server, a domain server, an Internet server, an Intranet server, a host server, a distributed server and the like, and the servers mentioned above may further include an interface capable of accessing a memory, a processor, a computer-readable storage medium, a storage medium, a communication device, a port, a client and other servers through wired/wireless networks.

In addition, the method, commands, codes and the like according to the present invention may also be executed by the server, and other devices needed to execute the method may be implemented as part of a hierarchical structure related to the server.

In addition, the server may provide an interface to other devices, unlimitedly including clients, other devices, printers, information base servers, print servers, file servers, communication servers, distributed servers and the like, and connections through the interface may facilitate remote execution of a program through wired/wireless networks.

In addition, any one of the devices connected to the server through the interface may further include at least a storage device which can store the methods, commands, codes and the like, and the central processor of the server may provide commands, codes and the like, which will be executed on different devices, to the devices to be stored in the storage device.

Meanwhile, in this specification, the method may be used in part or as a whole through a network infrastructure. Here, the network infrastructure may include all the devices such as a computing device, a server, a router, a hub, a firewall, a client, a personal computer, a communication device, a routing device and the like, in addition to separate modules which can execute their own functions. The network infrastructure may further include storage media such as a storage, a flash memory, a buffer, a stack, RAM, ROM and the like, in addition to the devices described above. In addition, the methods, commands, codes and the like may also be executed and stored by any one among the devices, modules and storage media included in the network infrastructure, and other devices needed to execute the methods may also be implemented as part of the network infrastructure.

In addition, the system and method described in this specification may be implemented as hardware or a combination of hardware and software suitable for a specific application. Here, the hardware includes all general-purpose computer devices such as a personal computer, a mobile communication terminal and the like and enterprise-specific computer devices, and the computer device may be implemented as a device including a memory, a microprocessor, a microcontroller, a digital signal processor, an application integrated circuit, a programmable gate array, a programmable array organization and the like or a combination of these.

The computer software, commands, codes and the like described above may be stored or accessed by a readable device, and here, the readable device may include memory such as a computer component provided with digital information used for computing during a predetermined time interval, a semiconductor storage such as RAM or ROM, a permanent storage such as an optical disk, a large capacity storage such as a hard disk, a tape, a drum or the like, an optical storage such as a CD or a DVD, a flash memory, a floppy disk, a magnetic tape, a paper tape, an independent RAM disk, a large capacity storage detachable from a computer, a dynamic memory, a static memory, a variable storage, a network attached storage such as a cloud, and the like. Meanwhile, here, although the commands, codes and the like include all of the information-oriented languages such as SQL, dBase and the like, system languages such as C, Objective C, C++, assembly and the like, architecture languages such as Java, .NET and the like, and application languages such as PHP, Ruby, Perl, Python and the like, it is not limited thereto, and all the languages known to those skilled in the art can be included.

In addition, the “computer-readable media” described in this specification include all media which contribute to providing commands to a processor for execution of a program. Specifically, although the media include nonvolatile media such as an information storage device, an optical device, a magnetic disk and the like, volatile media such as a dynamic memory and the like, and transmission media such as a coaxial cable, a copper wire, an optical fiber and the like for transmitting information, it is not limited thereto.

Meanwhile, the configurations executing technical features of the present invention included in the block diagrams and flowcharts shown in the accompanying drawings mean logical boundaries between the configurations.

However, according to the embodiments of software or hardware, since the configurations shown in the figures and functions thereof are executed in the form of an independent software module, a monolithic software structure, a code, a service or a combination thereof and the functions can be implemented as the configurations and functions are stored in a medium executable in a computer provided with a processor which can execute a stored program code, command or the like, all of these embodiments should also be regarded as being in the scope of the present invention.

Therefore, although the accompanying drawings and descriptions thereof describe technical features of the present invention, the features should not be simply inferred as far as specific arrangements of software for implementing the technical features are not clearly mentioned. That is, diverse embodiments as described above may exist, and since the embodiments may be partially modified while possessing technical features the same of those of the present invention, these embodiments should also be regarded as being in the scope of the present invention.

In addition, although the flowcharts illustrate the operations in the drawing in a specific order, these are shown in the drawings to get a most desirable result, and it should not be understood in a way that the operations should be executed in the illustrated specific order or all the operations shown in the drawings should be necessarily executed. In a specific case, multi-tasking and parallel processing may be advantageous. In addition, it should not be understood in a way that separation of diverse system components of the embodiments described above is not always requested in all embodiments, it should be understood that the described program components and systems can be generally integrated with each other as a single software product or packaged in a multi-software product.

As described above, this specification is not intended to limit the present invention by the presented specific terms. Accordingly, although the present invention has been described in detail with reference to the embodiments described above, those skilled in the art may make alterations, changes and modifications to the embodiments without departing from the scope of the present invention.

It should be interpreted such that the scope of the present invention is defined by the claims described below, rather than the detailed descriptions described above, and the meaning and scope of the claims and all the changed or modified forms derived from the equivalent concepts thereof are included in the scope of the present invention.

### INDUSTRIAL APPLICABILITY

The present invention relates to an Internet of Things security module easily that is interfaced with an electronic device to perform security functions including at least one among an authentication function, an encryption and decryption function, a random number generation function, and a storage function.

1. An Internet of Things security module comprising:
an interface unit interfaced with an electronic device to receive any one of security functions, including an authentication function, an encryption and decryption function, a random number generation function and a storage function, inputted by the electronic device; and
an authentication unit for determining whether an ID and a unique number of the electronic device inputted through the interface unit match an ID and a unique number stored in advance.

2. The Internet of Things security module according to claim 1, wherein the authentication unit outputs a match signal to the electronic device if the inputted ID and unique number match an ID and a unique number stored in advance.

3. The Internet of Things security module according to claim 1, further comprising an encryption and decryption unit for encrypting information to be encrypted on the basis of the information to be encrypted, an encryption method and a key value inputted through the Interface unit and outputting the encrypted information to the electronic device.

4. The Internet of Things security module according to claim 1, further comprising a random number generation unit for generating a random number on the basis of a random number size inputted through the Interface unit.

5. The Internet of Things security module according to claim 1, further comprising a storage unit for storing the unique number and the key value of the electronic device inputted through the Interface unit.
